(19) United States
(12) Patent Application Publication
(10) Pub. No.: US 2024/0059480 A1
(43) Pub. Date: Feb. 22, 2024

(54) CONTAINMENT SYSTEM

(71) Applicant: Cassondra Rykowski, Vista, CA (US)

(72) Inventor: Cassondra Rykowski, Vista, CA (US)

(21) Appl. No.: 17/892,985

(22) Filed: Aug. 22, 2022

(51) Int. Cl. B65F 1/06; B65F 1/16; B65B 31/04; B01D 46/00

(52) U.S. Cl. CPC B65F 1/06; B65F 1/1646; B65B 31/048; B65F 1/163; B01D 46/0038; B65F 2210/188; B65F 2210/168; B65F 2210/167

(57) ABSTRACT

A containment system is disclosed. The containment system includes a housing containing a cavity. A liner mount is positioned within the cavity to receive a liner. The liner holds contaminated items. The containment system includes an air exchanger within the cavity to evacuate air from an evacuation zone. The evacuation zone is between a lid-covered opening and the liner mount. Accordingly, air can be removed from the cavity to eliminate odors emitted by the contaminated items. Other embodiments are also described and claimed.

### FIELD

The present disclosure relates to containment systems. More particularly, the present disclosure relates to receptacles that temporarily store objects prior to composting, laundering, or disposing.

### BACKGROUND INFORMATION

Refuse is a natural byproduct of everyday living. Spoiled foods, soiled linens, and human/pet excreta are examples of items that are normally produced at work or in the community. Such items are commonly stored, temporarily, in vessels like trash cans, laundry hampers, and other pales or receptacles. The receptacles may contain bags, sacks, or liners, and the items can sit in the receptacles until the receptacles are filled and removed to be composted, laundered, or permanently disposed of outdoors.

### SUMMARY

Refuse may not be contained within homes and other buildings, and thus, air within the homes and other buildings can be polluted. More particularly, refuse can contain microorganisms capable of causing disease, or pathogens, which when not contained can enter bodies through the eyes, mouth, nose, or urogenital openings, or through wounds or bites that breach the skin barrier. Occupational hygiene is concerned with the anticipation, recognition, evaluation, and control of such environmental factors, e.g., chemical, physical, and microbiological agents and ergonomics, that may affect the health and well-being of individuals at work or in the community. Research in the area of occupational hygiene has indicated that the air within homes and other buildings can be more seriously polluted than the outdoor air in even the largest and most industrialized cities. Additionally, people spend approximately 90 percent of their time indoors. Thus, for many people, the risks to health may be greater due to exposure to air pollution indoors than outdoors. Furthermore, the people who may be exposed to indoor air pollutants for the longest periods of time can be those most susceptible to the effects of indoor air pollution. Such groups include the young, the elderly and the chronically ill, especially those suffering from respiratory or cardiovascular disease.

Existing receptacles do not limit airborne exposure to harmful agents within a living space. Air allows these contaminants to multiply. Whenever food scraps, wet/dirty laundry, or human and pet excreta are allowed to sit idle in the natural environment with the presence of air, it allows bacteria to flourish and contributes to the generation of pathogens and offensive odors. Accordingly, the spread of these bacteria can be reduced by limiting this contact between contaminants and the air within the vicinity.

The present invention provides a receptacle or containment system that uses ambient air exchange to reduce air contamination. The system can include a space to receive, hold, or store materials. The system can contain air using engineering controls either: to prevent the escape of materials hazardous to health into the surrounding environments, or to prevent the contamination or degradation of compounds by the environment. For example, the containment system can include a barrier to separate and surround the materials from the environment.

The containment system described herein can include a sealer to seal items in sealed compartments, which can reduce contaminant-to-air contact, or otherwise reduce contact between air and items that can contaminate the air. In an embodiment, the containment system includes a housing having a housing wall surrounding a cavity, and an opening over the cavity. A lid can be hinged to the housing to cover the opening. For example, the lid can be actuated by a foot pedal to open the lid and allow a user to place items into the containment system. A liner mount is disposed within the cavity, below the opening. The liner mount can receive a liner roll. The items that are added to the system through the opening can fill the liner roll.

An air exchanger is disposed within the cavity. The air exchanger has an inlet in fluid communication with an evacuation zone of the cavity. The evacuation zone can be between the opening and the liner mount. An outlet of the air exchanger can be in fluid communication with a vent. Accordingly, the air exchanger can be operable to move air from the evacuation zone through the vent to a surrounding environment.

Operation of the air exchanger to evacuate air from the evacuation zone can cause a low pressure region within the liner roll that cause the liner roll to collapse around the inserted item. A sealer can be located within the cavity, below the liner mount. The sealer can seal the liner roll above and below the item to form a compartment containing the item. Such a so-called baled item can isolate the item and reduce a likelihood that the item will grow bacteria or release odors into a surrounding environment.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 is a front view of a containment system, in accordance with an embodiment.

FIG. 2 is a top view of a containment system, in accordance with an embodiment.

FIG. 3 is a cross-sectional view of a containment system, in accordance with an embodiment.

FIG. 4 is a rear view of a containment system, in accordance with an embodiment.

FIG. 5 is a pictorial view of a liner containing items within sealed compartments, in accordance with an embodiment.

Embodiments describe a receptacle or containment system. The system can be used in various settings such as residences like an apartment, house, motorhome, etc., and in business and commercial settings like care facilities, restaurants, schools, etc. The containment system can limit the effects of harmful byproducts, reducing risks of environmental and human contamination.

In various embodiments, description is made with reference to the figures. However, certain embodiments may be practiced without one or more of these specific details, or in combination with other known methods and configurations. In the following description, numerous specific details are set forth, such as specific configurations, dimensions, and processes, in order to provide a thorough understanding of the embodiments. In other instances, well-known processes and manufacturing techniques have not been described in particular detail in order to not unnecessarily obscure the description. Reference throughout this specification to “one embodiment,” “an embodiment,” or the like, means that a particular feature, structure, configuration, or characteristic described is included in at least one embodiment. Thus, the appearance of the phrase “one embodiment,” “an embodiment,” or the like, in various places throughout this specification are not necessarily referring to the same embodiment. Furthermore, the particular features, structures, configurations, or characteristics may be combined in any suitable manner in one or more embodiments.

The use of relative terms throughout the description may denote a relative position or direction. For example, “above” may indicate a first direction relative to a reference point. Similarly, “below” may indicate a second direction opposite to the first direction. Such terms are provided to establish relative frames of reference, however, and are not intended to limit the use or orientation of a containment system to a specific configuration described in the various embodiments below.

In an aspect, a containment system is provided that includes a receptacle to hold items in a liner. The receptacle can incorporate components that limit contaminant-to-air contact. The components can include an air exchanger to remove air from an evacuation zone above the contaminated items. Furthermore, the containment system can incorporate a sealer to seal the liner and form individual bales of the contaminated items in sealed compartments. The liner may be compostable. Accordingly, the containment system provides a hygienic, odorless, and environmentally-friendly manner of storing contaminated items in various settings.

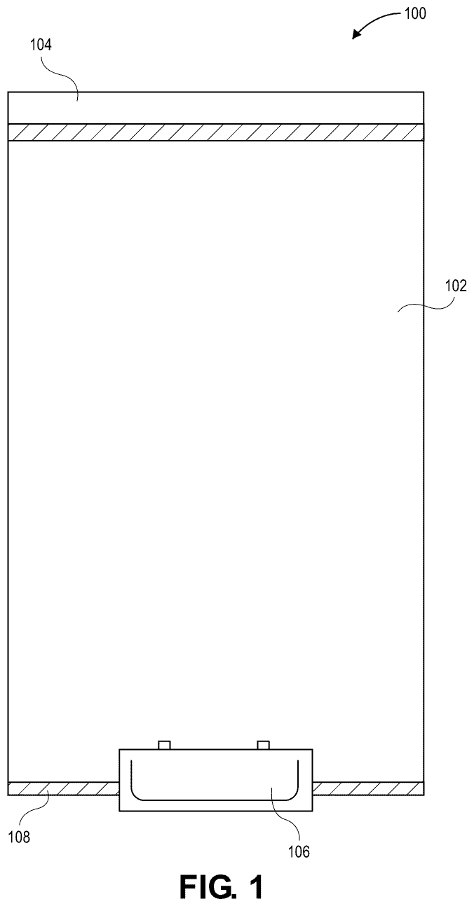

Referring to FIG. 1, a front view of a containment system is shown in accordance with an embodiment. A containment system 100 includes a receptacle for receiving and storing contaminated items. The containment system 100 can have a housing 102 to contain internal components of the containment system 100. The housing 102 may have a form factor appropriate to an application and/or environment within which the containment system 100 will be used. For example, the housing 102 may have an upright, cylindrical form factor.

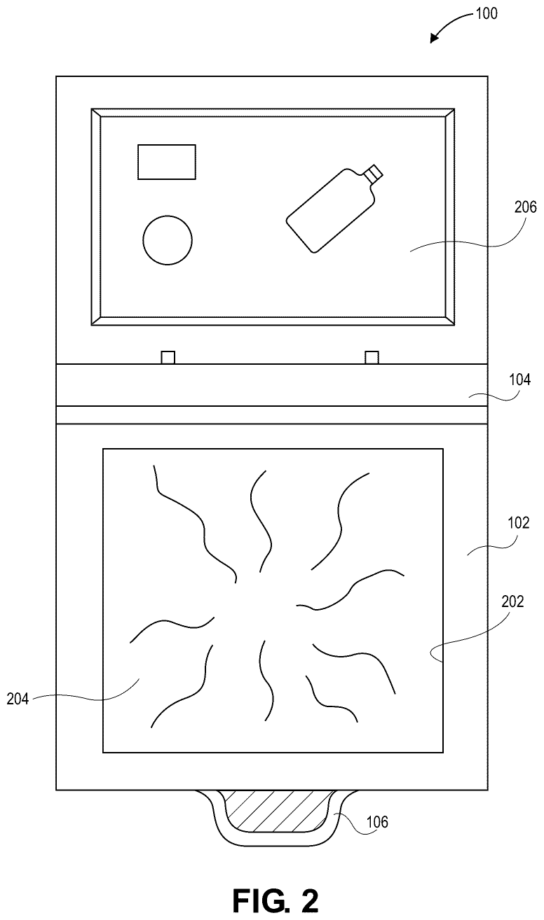

A lid 104 may be hinged to the housing 102. The lid 104 can cover an opening (FIG. 2) through which contaminated items are inserted into the containment system 100. More particularly, the lid 104 may be operable to open and close. Accordingly, the lid 104 may be moved to an open state to allow contaminated items to be inserted into the containment system 100, and a closed state to limit the exposure of an internal volume of the containment system 100 to a surrounding environment.

In an embodiment, the containment system 100 includes a foot pedal 106. The foot pedal 106 can be operably connected to the lid 104. For example, the foot pedal 106 may be hinged to the housing 102, and a linkage system may connect the foot pedal 106 to the lid 104. Actuation of the foot pedal 106 can operate the linkage to move the lid 104 between the open state in the closed state.

Operation of the foot pedal 106, e.g., stepping on the pedal, can apply side loads that could cause the containment system 100 to slide on the ground. Accordingly, the containment system 100 may include a rubber footing 108 on the housing 102. The rubber footing 108 can include one or more rubber feet attached to a bottom surface of the housing 102. Alternatively, the rubber footing 108 may be a rubberized portion of the housing 102, e.g., rubber over-molded onto a bottom edge of the housing 102. Accordingly, the housing 102 may be stabilized on the ground to allow a user to step on the foot pedal 106 without causing the containment system 100 to slip.

Referring to FIG. 2, a top view of a containment system is shown in accordance with an embodiment. As described above, the housing 102 can include an opening 202 that is exposed to the surrounding environment when the lid 104 is in the open state. The housing 102 can contain a cavity that is visible through the opening 202. More particularly, in the open state, a user can drop or otherwise insert contaminated items through the opening 202 into the cavity.

A liner 204 can be disposed within the cavity. The liner 204 is described in more detail below, however, at this point it will be understood that the liner 204 may be a continuous liner that receives contaminated items and may be sealed to form individualized compartments, or bales, containing the contaminated items. Accordingly, the foot pedal 106 may be pressed to open the lid 104 and allow contaminated items to be inserted through the opening 202 into the liner 204.

In an embodiment, the housing 102 includes a recess 206. The recess 206 can be adjacent to the lid 104. For example, the recess 206 may be separated from the opening 202 in a lateral direction by the lid 104, when viewed from above. The recess 206 may be concave upward. More particularly, the recess 206 can provide a basin or storage compartment that opens upward to the surrounding environment providing an ergonomic working station. Thus, the recess 206 may be used to store various items such as lotions, gels, and sprays, towels, clothing, bed linens, stain pretreatment, adult, child, and pet diapers, wipes, etc.

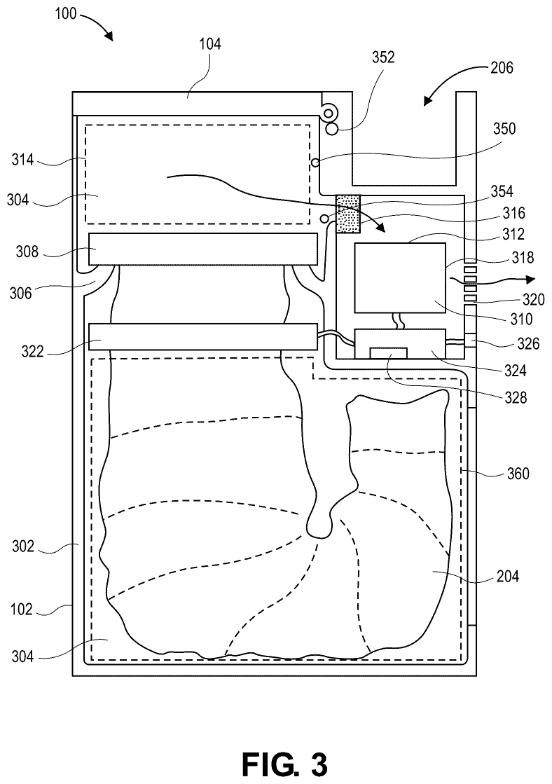

Referring to FIG. 3, a cross-sectional view of a containment system is shown in accordance with an embodiment. The housing 102 can include a housing wall 302 surrounding a cavity 304. As described above, the cavity 304 may be below the opening 202 that is formed in the housing 102 and covered by the lid 104. Accordingly, when the lid 104 is in the closed state, the cavity 304 may be defined as the space within the containment system 100 between the lid 104 in the housing wall 302.

A liner mount 306 may be positioned within the cavity 304 below the opening 202. The liner mount 306 may be integral to the housing wall 302, or the liner unit 306 may be a separate component attached to the housing wall 302. In an embodiment, the liner mount 306 includes a shelf, prongs, tabs, or another supporting structure that extends radially inward from the housing wall 302. The liner mount 306 can receive a liner roll 308. The liner roll 308 can include a continuous liner system. More particularly, the liner roll 308 can include a thin film bag, essentially a long cylindrical tubular film, that is wrapped onto an annular rim or spool. The tubular film can pass through a hole in the middle of the rim, and may be sealed at an end. Accordingly, the sealed tubular film forms a bag having a bag opening coincident with the hole in the middle of the annular rim. Contaminated items may therefore be dropped through the opening 202 in the housing 102 into the cavity 304, and may pass through the hole of the liner roll 308 to fall into and be contained within the liner bag.

In an embodiment, an air exchanger 310 is disposed within the cavity 304. The air exchanger 310 can circulate and/or transfer air from within the containment system 100 to the surrounding environment. For example, the air exchanger 310 can have an inlet 312 in fluid communication with an evacuation zone 314 of the cavity 304. The evacuation zone 314 can include a space above the liner mount 306 (and the liner roll 308). For example, the evacuation zone 314 can be between the opening 202 and the liner mount 306. Accordingly, a volume of air can be evacuated from the evacuation zone 314 into the inlet 312 of the air exchanger 310.

Optionally, the containment system 100 includes a charcoal filter 316 within the cavity 304. For example, the charcoal filter 316 can be positioned within or cover a passage connecting the evacuation zone 314 to a compartment that contains the air exchanger 310. As air is withdrawn from the evacuation zone 314 by the air exchanger 310, the air can pass through the charcoal filter 316. Accordingly, odors may be removed from the exhausted air to reduce a likelihood of spreading odors into the surrounding environment.

The air exchanger 310 can include an outlet 318. Air can be exhausted through the outlet 318, e.g., to transfer air in an outward direction toward the surrounding environment. For example, the outlet 318 may be in fluid communication with a vent 320. Air that is thus withdrawn from the evacuation zone 314 can pass through the inlet 312, the outlet 318, and the vent 320 to be exhausted to the surrounding environment. Accordingly, the air exchanger 310 is operable to move air from the evacuation zone 314 through the vent 320 to the surrounding environment.

The air exchanger 310 can include one or more air exchange components to produce ambient air exchange from the evacuation zone 314 to the surrounding environment. In an embodiment, the air exchanger 310 includes one or more fans. The one or more fans may, for example, include a series of fans that operate to generate a flow of air from the inlet 312 to the outlet 318. The fans can remove air by creating a pressure drop across the air exchanger 310 between the evacuation zone 314 and the vent 320 to exhaust air from the containment system 100.

In an embodiment, the air exchanger 310 includes a vacuum pump. Similar to the one or more fans, the vacuum pump operates to create a pressure drop across the air exchanger 310. The vacuum pump can connect to the inlet 312 and the outlet 318. Accordingly, the air exchanger 310 can transfer air from the evacuation zone 314 to the surrounding environment.

The containment system 100 can operate to form sealed compartments in the liner 204. The sealed compartments can contain individualized packets or bales of items, e.g., contaminated items, as described further below. In an embodiment, the liner 204 can be sealed at discrete locations by a sealer 322. The sealer 322 can be mounted within the cavity 304 below the liner mount 306. More particularly, the sealer 322 can be positioned below the liner roll 308, and the liner 204 can extend downward through sealer 322 toward an end of the bag.

In an embodiment, the sealer 322 includes a heat sealer. The sealer 322 can include opposing heating elements that pinch together to heat the liner 204 and form a seal across the liner 204. The seal can be a perforated seal, for example. More particularly, the sealer 322 can fuse the liner 204 and form perforations within the fused material. Accordingly, the baled items may be isolated from each other, and may be manually separable from each other by tearing the bales apart at a perforated seam.

The air exchanger 310, the sealer 322, and any other electrically-run components of the containment system 100 can be powered by a power unit 324. The power unit 324 can be electrically connected to one or more of the air exchanger 310 or the sealer 322 to power the components. For example, the power unit 324 can supply electrical power to a motor of the air exchanger 310, which drives the motor to spin the one or more fans or the internal componentry of the vacuum pump.

The power unit 324 can include a battery having terminals electrically connected to the system components, e.g., via intermediate circuitry. Alternatively, the power unit 324 can include an electrical plug 326 to connect to a wall outlet and to transfer electrical power to the system components, e.g., via intermediate circuitry. The power unit 324 may include a combination of the battery and the electrical plug 326. For example, the power unit 324 can include a USB-rechargeable battery to provide reliability, mobility, and convenience.

The internal circuitry of the containment system 100 may include a controller 328. The controller 328 can include one or more processors configured to execute instructions stored on a non-transitory computer readable medium. Alternatively, the controller 328 can include a programmable logic controller that is programmed to perform computer operations that drive the function of the containment system 100. In any case, the controller 328 can receive inputs about a state of the system, and generate outputs that drive the system operation.

In an embodiment, the containment system 100 includes one or more sensors to detect the state of the system. For example, one or more sensors may be mounted within the internal volume of the containment system 100 to detect various conditions, and to transmit signals corresponding to such conditions, to circuitry, e.g., the controller 328.

The containment system 100 can include a pressure sensor 350. The pressure sensor 350 can be mounted within the evacuation zone 314, e.g., on the housing wall 302 surrounding the evacuation zone 314. Accordingly, the pressure sensor 350 can detect air pressure within the evacuation zone 314. In an embodiment, the pressure sensor 350 is electrically connected to circuitry. The pressure sensor 350 can deliver a signal corresponding to the air pressure within the evacuation zone 314. The circuitry can operate to activate, in response to the air pressure being below a predetermined threshold, the sealer 322. For example, when air is suctioned out of the evacuation zone 314, the pressure drop above the liner roll 308 can cause the liner 204 to collapse between the liner roll 308 and the sealer 322. When the liner 204 is collapsed, the sealer 322 can be activated to fuse the liner roll 308 and form a baled item.

The containment system 100 can include a lid sensor 352. The lid sensor 352 can be coupled to the lid 104, e.g., to a hinge of the lid. Accordingly, the lid sensor 352 can detect whether the lid 104 is in the open state or the closed state. In an embodiment, the lid sensor 352 is electrically connected to circuitry. The lid sensor 352 can deliver a signal corresponding to the open/closed state of the lid 104 to the circuitry. The circuitry can operate to activate, in response to the lid 104 having moved from the open state to the closed state, the sealer 322. For example, when the user deposits items into the liner 204 and closes the lid 104 by stepping off of the foot pedal 106, the lid 104 can close to seal the evacuation zone 314, and the air exchanger 310 can be activated to evacuate air from the evacuation zone 314 prior to sealing the liner 204 to form a baled item.

The containment system 100 can include a liquid sensor 354. The liquid sensor 354 can be mounted within the evacuation zone 314 near the liner mount 306. For example, the liquid sensor 354 can be above or beside the liner mount 306. Placement of the liquid sensor 354 may be selected such that liquid overflow from the liner roll 308 will activate the liquid sensor 354. More particularly, the liquid sensor 354 can detect liquid and, in the event 320 that liquid is detected, the liquid sensor 354 can transmit a signal to circuitry. The circuitry can deactivate the air exchanger 310 in response to such signal, when liquid is detected. Accordingly, a risk of suctioning liquid into the air exchanger 310 can be reduced, and system reliability may be facilitated.

The electronic circuitry that receives signals from the sensor(s) of the containment system 100 may include one or more processors, as described above. Alternatively, the circuitry can include a timed relay. In any case, operation of the air exchanger 310 based on signals received from the one or more sensors may be controlled to occur for a particular duration. For example, evacuation of air may be controlled to occur after the lid 104 is closed until the baled item is sealed. In any event 320, the air exchanger 310 may be deactivated when the lid 104 is open, based on signals generated by the lid sensor 352, for example.

In an embodiment, the cavity 304 of the containment system 100 includes a containment zone 360. The containment zone 360 can be below the liner mount 306. The containment zone 360 can occupy a bottom portion of the containment system 100, and may be wider than the evacuation zone 314. For example, the containment zone 360 may be below both the evacuation zone 314, and below the compartment containing the air exchanger 310, power unit 324, and controller 328. As the liner roll 308 is filled with items, e.g., contaminated items, and the baled items are formed by the sealer 322, the bales can drop downward into the containment zone 360. The containment zone 360 can contain and store the baled items until the user is ready to remove and discard the bales.

A method of using the containment system 100 may therefore include several operations, performed manually or automatically. A user can open the lid 104, e.g., by stepping on the foot pedal 106. Items, e.g., contaminated items, can be placed into the system. For example, a food item can be dropped into the opening 202 to fall into the liner roll 308. The lid 104 may be allowed to close by stepping off of the foot pedal 106. When the lid 104 closes, the air exchanger 310 can be activated to vacuum air from the evacuation zone 314 and the upper region of the liner roll 308. The air, which may be filtered, can be exhausted into the surrounding environment. The sealer 322 may then be activated to fuse the liner 204 and/or form perforations in the seal. Accordingly, baled items may be formed and stored within the containment zone 360. The isolated bales can be hermetically sealed to reduce a likelihood of releasing odors into the surrounding environment.

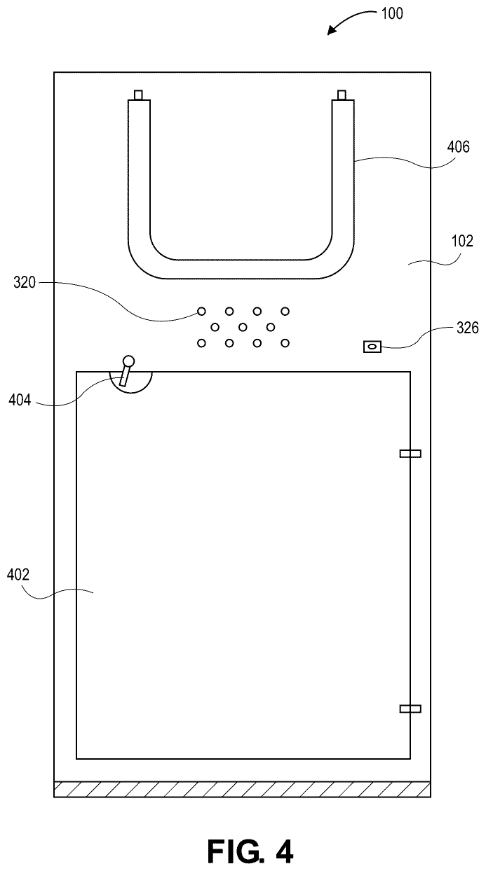

Referring to FIG. 4, a rear view of a containment system is shown in accordance with an embodiment. The containment system 100 can include a door 402 in the housing 102 to provide access to the containment zone 360. The door 402 can be on a side of the housing 102, e.g., a section of the housing wall 302, and may be hinged to allow the user to swing the door 402 open to expose the containment zone 360. In an embodiment, the door 402 between the containment zone 360 and the surrounding environment can be fastened by a latch 404. For example, the latch 404 can be a pivot or swivel latch that can be lowered to block the door 402 from opening, or raised to release the door. When released, the door 402 can be swung outward to expose the containment zone 360. The user can then reach in to grab and remove the baled items that are stored within the cavity 304 of the containment system 100.

The containment system 100 can include components to enhance the ergonomics and functionality of the system. One such feature can be a bail handle 406. The bail handle 406 can be coupled to the housing 102, e.g., above the vent 320. The bail handle 406 may be formed in the housing wall 302, or be a separate pivoted handle. In any case, the user may grab the bail handle 406 to lift and transport the system, e.g., to carry the unit.

Referring again to FIG. 4, the containment system 100 can include a damper mechanism operably coupled to the lid 104. The damper mechanism can provide a repeatable, soft closing of the lid 104 when the user steps off of the foot pedal 106. The damper mechanism can be a soft-closing hinge, for example. The damper mechanism can enhance the function of the system by reducing wear on the system components and providing repeatable lowering the lid 104 into a sealed position over the evacuation zone 314.

Another ergonomic feature that may be incorporated into the containment system 100 is a holding pail or bucket (not shown) that can be disposed within the containment zone 360. The holding pail may be positioned within the containment zone 360 below the liner roll 308 to receive the baled items as they are formed. The holding pail can be sized and shaped to fit within the containment zone, and may be accessible and removable through the door 402. For example, the holding pail can have a cylindrical form factor that fits within and conforms to the housing wall 302. The holding pail may have a bail handle. The bail handle can be connected to the holding pail to provide a grip for a user. Accordingly, when the holding pail is filled with baled item(s), the user may easily grasp the bail handle, remove the holding pail from the system, and carry the holding pail for disposal.

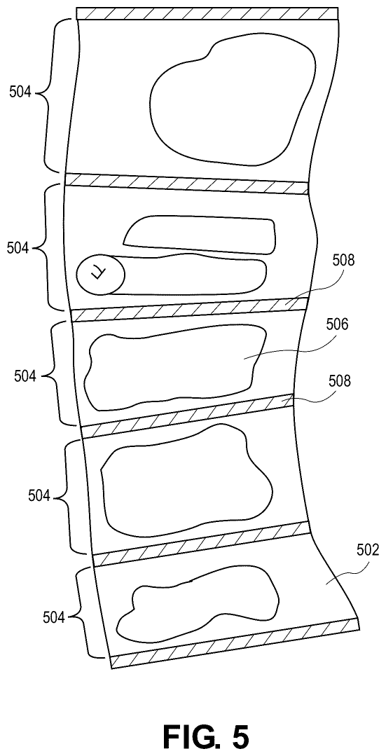

Referring to FIG. 5, a pictorial view of a liner containing items, e.g., contaminated objects, within sealed compartments is shown in accordance with an embodiment. The continuous liner, which is dispensed from the liner roll 308 and sealed by the sealer 322 to form sealed compartments 502 containing baled items 504, may be formed from a compostable material. For example, the compostable material can be a compostable plastic. The liner 204 may therefore be an environmentally-friendly alternative to non-compostable bags. More particularly, the baled items 504 can be disposed of within the “green” bins and disposed of accordingly, in an environmentally-friendly manner.

In an embodiment, the liner 204 is formed from a lignin-based composite. The lignin-based material can be a bio-renewable, natural aromatic polymer with biodegradable properties. The material may be formed from a percentage of, e.g., 20%, recycled material. A resin additive may be used to cause the lignin-based material to fully degrade within a landfill, or underground, within 1 to 5 years.

As described above, each baled item 504 within the sealed compartments 502 can include items 506, e.g., soiled linens, diapers, food, and other compostable items and/or contaminated items, etc. The item 506 can be contained between a pair of seals 508, e.g., a lower seal and an upper seal. The seals 508 can be hermetic seals, formed by fusing the liner 204 together. Given that the bales are vacuum sealed, the system removes oxygen from the bales and deprives pathogens within the item 506 from the oxygen, which can limit the growth of mold and bacteria within the bales. Accordingly, the item 506 can be hermetically contained within the baled items 504 to reduce a likelihood of contaminating or infusing the surrounding environment with obnoxious odors.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A containment system, comprising:
a housing including a housing wall surrounding a cavity and an opening over the cavity;
a lid hinged to the housing to cover the opening;
a liner mount within the cavity below the opening, wherein the liner mount is to receive a liner roll; and
an air exchanger within the cavity, wherein the air exchanger has an inlet in fluid communication with an evacuation zone of the cavity between the opening and the liner mount, and an outlet in fluid communication with a vent, and wherein the air exchanger is operable to move air from the evacuation zone through the vent to a surrounding environment.

2. The containment system of claim 1, wherein the air exchanger includes one or more fans.

3. The containment system of claim 2, wherein the one or more fans includes a series of fans.

4. The containment system of claim 1, wherein the air exchanger includes a vacuum pump.

5. The containment system of claim 1 further compromising a sealer configured to form perforated seals between a baled item within the cavity below the liner mount.

6. The containment system of claim 5 further comprising a power unit electrically connected to one or more of the air exchanger or the sealer.

7. The containment system of claim 6, wherein the power unit includes a battery.

8. The containment system of claim 6, wherein the power unit includes an electrical plug.

9. The containment system of claim 5 further comprising:
a pressure sensor to detect air pressure within the evacuation zone, and
circuitry electrically connected to the pressure sensor to activate the sealer when the pressure sensor detects that the air pressure is below a predetermined threshold.

10. The containment system of claim 1, wherein the housing includes a recess adjacent to the lid, and wherein the recess is concave upward.

11. The containment system of claim 1 further comprising a foot pedal operably connected to the lid, wherein actuation of the foot pedal moves the lid between an open state and a closed state.

12. The containment system of claim 11 further comprising a damper mechanism operably coupled to the lid.

13. The containment system of claim 11 further comprising:
a lid sensor to detect when the lid is in the open state or the closed state, and
circuitry electrically connected to the lid sensor to activate the air exchanger when the lid sensor detects that the lid has moved from the open state to the closed state.

14. The containment system of claim 1 further comprising:
a liquid sensor to detect liquid, and
circuitry electrically connected to the liquid sensor to deactivate the air exchanger when liquid is detected.

15. The containment system of claim 1, wherein the cavity includes a containment zone below the liner mount and the air exchanger.

16. The containment system of claim 15 further comprising a door in the housing between the containment zone and the surrounding environment.

17. The containment system of claim 16 further comprising a latch to fasten the door.

18. The containment system of claim 1 further comprising a charcoal filter within the cavity.

19. The containment system of claim 1 further comprising a rubber footing on the housing.

20. The containment system of claim 1 further compromising a bail handle coupled to the housing.
